(19) United States
(12) Patent Application Publication
(10) Pub. No.: US 2010/0136442 A1
(43) Pub. Date: Jun. 3, 2010

(54) Hydrogen production by water dissociation in the presence of SnO using the SnO2/SnO couple in a series of thermochemical reactions

(75) Inventors: Stephane Abanades, Les Angles (FR); Patrice Charvin, Saint Romans (FR); Gilles Flamant, Llo (FR); Florent Lemort, Villeneuve les Avignon (FR)

Correspondence Address: NICOLAS E. SECKEL;Patent Attorney, 1250 Connecticut Avenue, NW Suite 700, WASHINGTON, DC, 20036, US

(73) Assignees: CENTRE NATIONAL DE LA RECHERCHE SCIENTIFIQUE, Paris (FR); COMMISSARIAT A L'ENERGIE ATOMIQUE, Paris (FR)

(21) Appl. No.: 12/529,019

(22) PCT Filed: Feb. 27, 2008
(86) PCT No.: PCT/FR2008/050295

§ 371 Date: Jan. 22, 2010

(30) Foreign Application Priority Data
Feb. 27, 2007 (FR) 07 53533

(51) Int. Cl. C01B 3/10; B01J 19/00; H01M 8/06

(52) U.S. Cl. 429/421; 423/657; 422/198

(57) ABSTRACT

The invention relates to a method for preparing hydrogen that comprises a hydrolysis step (C) of solid SnO for producing hydrogen, in which the hydrogen thus produced is stored, recovered and/or upgraded, and in which the solid SnO used is obtained by the following steps: (A) thermal reduction of SnO₂ into SnO in conditions yielding gaseous SnO; and (B) cooling the gaseous SnO thus produced to a temperature lower than or equal to % 50° C. The invention also relates to devices and equipments for implementing said method.

The invention relates to a process for producing hydrogen and devices capable of implementing the process.

Hydrogen is conventionally produced by the steam reforming of natural gas, which produces greenhouse gas emissions.

An alternative method of providing hydrogen involves the use of thermochemical cycles using fuels other than conventional carbonaceous hydrocarbons. These cycles have the advantage, inter alia, of not emitting CO₂.

Thermochemical cycles enable hydrogen to be produced by thermally decomposing water by providing energy without the emission of greenhouse gases. The cycles are basically a series of reactions, which can be summarized as follows: H₂O→H₂+½O₂.

Direct decomposition of water requires a reaction temperature of greater than 2,500° C. The use of chemical cycles enables this temperature to be reduced.

In view of this, few cycles are used specifically for thermodynamic or thermal reasons.

FR 2 135 421 discloses a hydrogen production process based on a series of reactions involving the pairs SnO/SnO₂ and Sn/SnO. The process comprises a step of forming Sn and SnO₂ by the disproportionation of SnO. Sn is subsequently hydrolyzed and becomes oxidized into SnO₂ to form dihydrogen. However, the step of separating Sn, SnO₂ and SnO is awkward and the reaction rate of the Sn hydrolysis step is slow.

In addition, a hydrogen production process based on the pair Fe₃O₄/FeO is disclosed in particular in the publications Sibieude F., Ducarroir M., Tofighi A., Ambriz J. J., High temperature experiments with a solar furnace: the decomposition of Fe₃O₄, Mn₃O₄, CdO, Int. J. Hydrogen Energy, 7-1, 79, 1982 and Steinfeld A., Sanders S., Palumbo R., Design aspects of solar thermochemical engineering—a case study: two-step water-splitting cycle using the Fe₃O₄/FeO redox system, Solar Energy, 65(1), 43-53, 1999. The hydrogen production process based on the Fe₃O₄/FeO pair has the drawback that it requires the large amounts of solid FeO produced in the Fe₃O₄ reduction process to be managed and generally transported. The process also requires an elevated temperature for the Fe₃O₄ reduction process, which has implications in terms of costs in particular and the choice of materials resistant to elevated temperatures and only generally results in the partial hydrolysis of FeO owing to the passivation of the FeO surface, thus having a negative impact on efficiency.

More interestingly, the pair ZnO/Zn has been proposed and studied, for example, in the publications Steinfeld A., Solar hydrogen production via a two-step water-splitting thermochemical cycle based on Zn/ZnO redox reactions, Int. J. Hydrogen Energy, 27(6), 611-619, 2002 and Wegner K., Ly H. C., Weiss R. J., Pratsinis S. E., Steinfeld A., In situ formation and hydrolysis of Zn nanoparticles for H₂ production by the 2-step ZnO/Zn water-splitting thermochemical cycle, Int. J. Hydrogen Energy, 31(1), 55-61, 2006. In a first step, ZnO is reduced to Zn by releasing oxygen then, in a second step, Zn is hydrolyzed, thus producing the desired hydrogen. However, the extremely rapid oxidation process of forming ZnO from Zn in the presence of O₂ renders the use of this pair impractical on an industrial scale and again limits the efficiency of the hydrogen production process. In fact, the step of reducing ZnO to Zn requires that the oxygen and Zn be separated in very short period of time to prevent them from recombining

An object of the present invention is to provide a new rapid hydrogen production process which is simple to implement on an industrial scale and which provides a good level of chemical and energy efficiency.

For this purpose, according to a first aspect, the invention provides a hydrogen production process, comprising a step (C) of hydrolyzing solid SnO, which produces hydrogen, in which the hydrogen produced is stored, recovered and/or enriched and the solid SnO used is obtained in accordance with the following steps:

(A) thermal reduction of SnO₂ to form SnO in conditions resulting in gaseous SnO; and

(B) cooling of the gaseous SnO thus produced to a temperature lower than or equal to 550° C., causing the SnO to condense in the form of solid particles.

The process according to the invention thus most commonly consists of or comprises the series of the following steps, between other optional steps:

(A) thermal reduction of stannic oxide (SnO₂) into stannous oxide (SnO) in conditions resulting in gaseous SnO; then

(B) cooling of gaseous SnO thus produced to a temperature lower than or equal to 550° C., thus producing SnO in the form of solid particles; then

(C) hydrolysis of the SnO formed, thus forming hydrogen, and recovery of the hydrogen thus formed.

The steps can be summarized schematically as follows:
(A) SnO₂→SnO (g)+½O₂
(B) SnO (g)→SnO (s)
(C) SnO (s)+H₂O→SnO₂+H₂.

In addition to the aforementioned steps (A), (B) and (C), the process may also comprise other steps, in particular intermediate separation steps.

The process according to the invention has the advantage that it requires only two chemical reactions to be carried out—one in step (A) based on the reduction of SnO₂, and the other in step (C) based on the hydrolysis of SnO.

The process according to the invention has the advantage of being simple to implement on an industrial scale. In particular, hydrogen is produced in step (C), which is distinct from step (A), in which oxygen O₂ is formed, thus avoiding an additional, awkward step of separating the two gases. Oxygen can thus be easily separated from the solid SnO produced in step (B) prior to the formation of hydrogen.

Furthermore, no by-products capable of reducing efficiency are produced in steps (A), (B) and (C), thus enabling highly pure hydrogen to be obtained.

In addition, the process of the invention enables high overall chemical efficiency of the hydrogen-producing cycle, typically around 75%, to be obtained. More specifically, the efficiency of step (A) can easily reach 80 to 85% and that of step (C) can attain values of approximately 90%.

The intrinsic energy efficiency of the SnO₂/SnO cycle, based on the GCV (gross calorific value) of hydrogen (286 kJ/mol), corresponds to the ratio between the enthalpy ΔH of the production of water ΔH_{H2+1/2O2→H2O} and that of the reduction of SnO₂ ΔH_{SnO2(298K)→SnO 1/2O2(1900K)}. For example, the aforementioned efficiency is approximately 42% for a reaction temperature of 1,900 K. This efficiency may be optimized by recovering heat within the process.

It has further advantageously been found that the chemical reaction rate of the process of the invention, in particular that of step (C), is rapid in particular in comparison with the Sn hydrolysis step carried out in the process of patent FR 2 135 421. For example, during step (C) of the process of the invention, 90% of the SnO is generally hydrolyzed in less than 20 minutes at a temperature substantially equal to 525° C.

The process of the invention has a further specific advantage, that is to say that the solid SnO obtained at the end of step (B) is a stable compound which has the advantage of being storable and transportable. It should be noted in particular that SnO and O₂ do not recombine at ambient temperature and the SnO oxidation reaction only begins around 200° C. at a slow reaction rate. For example, 20 to 30% of SnO is reoxidized to form SnO₂ in approximately 10 minutes as it is heated to a temperature of between 200° C. and 500° C. Step (C) of producing hydrogen of the process according to the invention may thus be carried out immediately after the formation of solid SnO in step (B) or may be carried out at a different site. Steps (A), (B) and (C) may thus be carried out in the same facility, or alternatively, steps (A) and (B) may be carried out at a first site and step (C) performed at a second site differing from the first. Moreover, solid SnO is generally not sensitive to atmospheric moisture and only hydrolyses to a very small degree at ambient temperature, thus ensuring ease of storage without having to take specific measures to achieve this.

Different features and variants of the process of the invention will now be described in greater detail.

SnO₂, which is used in the process of the invention, has the advantage of being a non-toxic, non-corrosive, plentiful and low-cost reagent.

In a preferred embodiment, the SnO₂ introduced in step (A) is in the form of solid particles.

It should be noted that step (C) of the process of the invention advantageously results in the formation of SnO₂ in a recoverable form, generally solid SnO₂ particles. The process of the invention may advantageously comprise the implementation of the successive steps (A), (B) and (C) in the form of a cycle in which all or part of the SnO₂ formed in step (C) is recycled in step (A). Furthermore, this cycle only comprises two successive chemical reactions which limits the amount of intermediate compounds and side reactions, thus achieving greater efficiency.

This embodiment represents a particular object of the present invention.

The reduction reaction carried out in step (A) is endothermic and thus requires an external supply of energy. Specifically, the enthalpy of the reaction is approximately 557 kJ.mol_{SnO2}⁻¹ at 1630° C. In a preferred embodiment, the thermal reduction of step (A) is achieved using high-temperature thermal energy, in particular thermal energy from a source of solar origin. In one embodiment, the thermal energy in step (A) is provided by a device which enables solar energy to be concentrated and is of the type formed by a solar power tower and a heliostat field or a parabolic concentrator. The use of concentrated thermal energy from a source of solar origin enables temperatures to be obtained which are greater than those provided by a source of heat of nuclear origin, typically approximately 850° C. for generation IV nuclear reactors. Furthermore, solar energy has the advantage of being a non-polluting, renewable energy source which can be used safely on an industrial scale.

Step (A) is generally carried out at atmospheric pressure and at a temperature of between 1,530° C. and 2,500° C., preferably less than or equal to 1,900° C., and even more preferably at approximately 1,600° C. At temperatures above 1,530° C., the SnO₂ reduction process forms gaseous SnO. The temperature of step (A) is advantageously lower than the vaporization temperature of SnO₂, i.e. 2,500° C. at atmospheric pressure, meaning that the SnO₂ is not in a gaseous form, therefore enabling SnO₂ and gaseous SnO to be separated more easily and avoiding any competition between the SnO formation reaction and the vaporization of SnO₂. The formation of the volatile component SnO, which is in a gaseous phase at temperatures greater than approximately 1,530° C., allows the solid reagent SnO₂ to be separated directly. Furthermore, temperatures exceeding 1,900° C. at atmospheric pressure for the reduction step (A) have numerous drawbacks, such as the cost of the heating system and the required use of a specific facility made of materials capable of withstanding such an elevated temperature.

In general, the reduction reaction of step (A) is carried out at atmospheric pressure. The aforementioned temperature ranges are given with reference to implementation at atmospheric pressure. If the reaction is carried out under reduced pressure, the temperature values are to be modified in particular as a function of the pressure applied. Therefore, reducing the pressure also reduces the reduction temperature and thus improves the reaction rate. For example, on the basis of Arrhenius' law k=k₀.exp(−Eₐ/RT) and an overall order reaction of 1, the rate constant k₀ increases from approximately 1.40×10⁸ s⁻¹ at atmospheric pressure, to approximately 7.31×10⁸ s⁻¹ at approximately 0.1 bar, and to approximately 1.24×10¹⁰ s⁻¹ at 0.01 bar. The activation energy of the reaction Eₐ is approximately 424 kJ/mol. An increase in the reduction temperature or the inert gas flow rate, the gases being Ar or N₂ for example, also enables the reaction rate to be improved.

The SnO obtained in step (A) is specifically in a gaseous form. This gaseous form enables SnO to be separated simply and rapidly from SnO₂ by phase separation and enables the SnO to be conveyed simply and rapidly, for example by an inert gas flow comprising Ar or N₂ for example, or by suction.

In step (B) of the process of the invention, the gaseous SnO formed in step (A) is cooled to a temperature lower than or equal to 550° C. The purpose of this cooling, inter alia, is to prevent the disproportionation of SnO into SnO₂ and Sn, which is intended in document FR 2 135 421. In the process of the invention, it is important in particular to keep SnO in its present state for the subsequent hydrolysis thereof in step (C). It is to be noted that steps (A) and (B) are generally carried out in separate zones within a single installation. However, it would also be possible for steps (A) and (B) to be carried out within the same reactor with two different temperature zones.

In practice, the cooling process in step (B) is carried out by causing the temperature of the gas flow comprising O₂ and gaseous SnO to fall rapidly from the temperature of step (A) to a temperature lower than or equal to 550° C., typically by injecting a stream of inert, cold gas into the gas flow at the temperature of step (A) or by heat exchange using a heat exchanger containing a coolant. In an embodiment, the cooling process of step (B) is carried out at atmospheric pressure. At temperatures lower than or equal to 1,530° C., SnO condenses by nucleation, enabling O₂ and SnO to be separated by simple phase separation and thus also limiting the reoxidation of SnO into SnO₂.

The cooling in step (B) is most commonly a quenching process, generally producing solid SnO particles with a particle size of between 1 nm and 100 nm, preferably between 10 and 50 nm, generally having high specific surface areas.

The fact that solid SnO can be obtained in the form of particles of this type in step (B) has numerous advantages. Firstly, the high specific surface area of solid SnO enables rapid hydrolysis reaction rates to be achieved. Furthermore, mass transfer and heat transfer are not limiting factors, as would be the case for particles with diameters greater than a micrometer. Moreover, the high surface area/volume ratio encourages a complete reaction in step (C). In addition, the solid SnO particles obtained are able to be carried by a gas flow on account of the small size thereof, which enables a continuous injection of SnO into the hydrolysis reactor up to the zone in which step (C) is carried out to be achieved. Furthermore, the nanoscale particle size obtained limits the effect of passivation which could be encountered in the hydrolysis step for particles of a greater size, for example particles with a diameter greater than 1 μm and which would otherwise decrease the overall efficiency of the hydrolysis reaction. These effects are produced by the formation of a layer of oxide on the particle surface which limits the diffusion of gases, water vapor in particular, into the particle towards the reaction front. It should be noted that limiting effects of this type are systematically observed in the processes involving ZnO/Zn and Fe₃O₄/FeO pairs.

In one embodiment, at least some of the heat from the gas flow comprising gaseous SnO, O₂ and optionally an inert carrier gas such as Ar or N₂ is recovered to be used in the process. In particular, the heat from the cooling process in step (B) may be used to heat the water used in the hydrolysis step (C), for example to vaporize said water into water vapor. In this context, in an advantageous variant, the hydrolysis step (C) uses water vapor provided by a heat exchanger in which water is used as a coolant, this exchanger recovering at least some of the heat from the cooling process of step (B), which includes in particular the sensible energy of the products obtained in the gas flow and the heat of condensation of gaseous SnO. In the present description, the term “sensible heat” or “sensible energy” refers to the energy or amount of heat exchanged without a physical phase transition between two elements which form an isolated system.

The hydrolysis reaction in step (C) is exothermic with an enthalpy of approximately −49 kJ.mol⁻¹ at 500° C. The hydrolysis in step (C) is carried out at a temperature lower than 600° C. and at atmospheric pressure. This reaction is typically performed at a temperature of between 450° C. and 550° C. at atmospheric pressure. The temperature of the hydrolysis reaction (C) is lower than or equal to 600° C. as SnO would otherwise begin to disproportionate which would limit the efficiency of the hydrolysis reaction (C) in which H₂ is formed.

As mentioned above in the present description, the SnO₂ from the hydrolysis reaction in step (C) is preferably recycled in the reduction reaction in step (A), thus causing the steps (A) (B) and (C) to be implemented in the form of a cycle. In a particular embodiment, the process of the invention could thus be carried out without consuming or causing the loss of solid reagents. The process can therefore be carried out in a cyclical manner, consuming only water and producing only gaseous effluents, i.e. oxygen and the desired hydrogen.

The hydrolysis reaction in step (C) is generally virtually complete, with very high rates of conversion of SnO and H₂O into SnO₂ and H₂, typically approximately 90% at 525° C. The reaction in step (C) enables up to approximately 7.4 moles of H₂ to be produced per kilogram of SnO. The maximum amount of hydrogen produced is approximately 166 N1_{H2}.kg_{SnO}⁻¹, N1 corresponding to volume in normal liters, that is to say that the volume is determined under normal conditions, i.e. at 0° C. and at 101 300 Pa (NTP). The amount by weight of hydrogen produced relative to the weight of SnO is 1.48×10⁻² kg_{H2}/kg_{SnO}, resulting in a weight capacity of approximately 1.48%.

The process according to the invention further comprises a step of recovering, storing and/or enriching the hydrogen obtained in step (C). The hydrogen obtained at the end of step (C) may thus, for example, be stored in its present state for subsequent use, or used immediately in a chemical reactor or utilized in a fuel cell, for example a PEMFC (“proton exchange membrane fuel cell”). It should be noted in this respect that the hydrogen obtained is highly pure which allows it to be used in reactions in the field of fine chemistry or, for example, in proton exchange membrane fuel cells (PEMFCs). The hydrogen obtained specifically does not contain any products capable of poisoning catalysts. In particular, it does not contain carbon oxide compounds which act as poisons of the catalysts in PEMFCs.

According to a second aspect, the invention also relates to a device for implementing step (C) of the process according to the invention, comprising:
a hydrolysis reactor provided with:
a first inlet for introducing solid SnO, as obtained from steps (A) and (B) defined above, into said hydrolysis reactor;
a second inlet connected to water supply means; and
an outlet for discharging the hydrogen formed; and
means for recovering and/or enriching the dihydrogen formed as it exits the hydrolysis reactor.

According to other embodiments, the device comprises at least one of the optional features below:
the water supply means supply water in the form of water vapor, produced in particular by the energy recovered within the process,
the hydrolysis reactor is provided with heating means.

As emphasized earlier in the description, the device of the invention may be located on the same site at which steps (A) and (B) are carried out, or at a different site.

According to a particular embodiment, the device of the invention can be used to supply a hydrogen fuel cell. In this respect, according to a third aspect, the invention relates to a fuel cell comprising the device according to the invention as a hydrogen generator. The fuel cell is generally connected to a vessel containing solid SnO, and water is reacted with the SnO contained in this vessel to produce the hydrogen which is supplied to the anode.

According to a fourth aspect, the invention relates to a facility for implementing the process according to the invention comprising the device according to the invention, associated with:
a reactor for reducing SnO₂ into SnO provided with conveying means which are connected to an inlet for introducing SnO₂ and provided with an outlet for discharging gaseous SnO;
means for cooling the gas flow containing the gaseous SnO which are connected to the outlet of the reduction reactor and are suitable for converting gaseous SnO into solid SnO;
means for conveying solid SnO from the cooling means, said conveying means being connected to the first inlet of the hydrolysis reactor.

In other embodiments, the facility may comprise one or another of the additional features below considered in isolation or in any technically feasible combination:
the facility further comprises means for extracting gaseous oxygen which are suitable for extracting gaseous oxygen and are arranged between the means for cooling gaseous SnO and the inlet of the hydrolysis reactor;
the reduction reactor is further provided with means for heating by way of a source of thermal energy of solar origin;
the means for cooling gaseous SnO comprise a heat exchanger, the coolant of which comprises water, and in which the water supply means comprise means for conveying the water heated in the heat exchanger towards the second inlet of the hydrolysis reactor;
the means for cooling gaseous SnO comprise means for injecting a cold inert gas into the flow containing the gaseous SnO;
the means for recovering and/or enriching the hydrogen formed further comprise a means for separating the hydrogen and the excess water vapor introduced into the hydrolysis reactor;
the facility further comprises SnO₂ recycling means enabling SnO₂ to be carried from the outlet of the hydrolysis reactor to the inlet of the reduction reactor;
the facility is an industrial hydrogen production unit in which the hydrogen obtained is stored in its present state for subsequent use or in which the hydrogen is used immediately, for example in a chemical reactor or a fuel cell.

A clearer understanding of the invention shall be obtained in light of the following non-limiting examples which are given in reference to the figures below, in which:

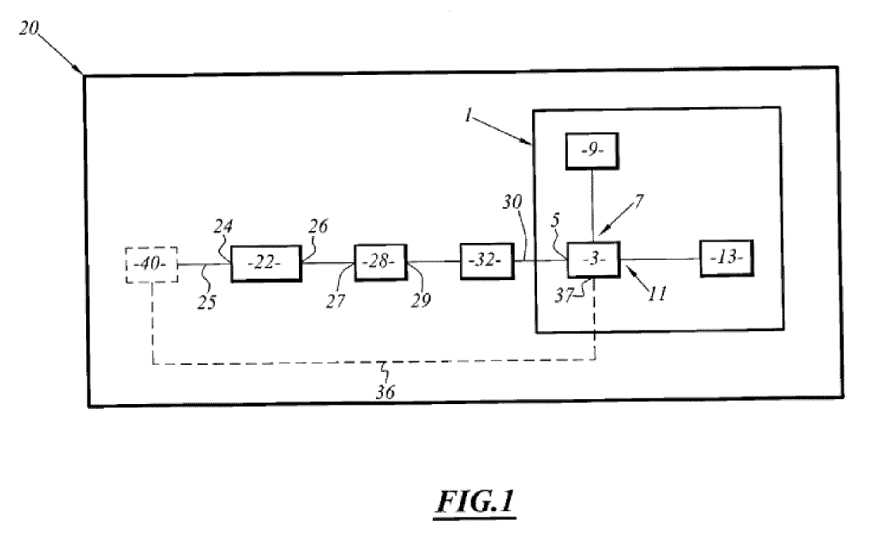

FIG. 1 is a schematic diagram of the production of hydrogen in accordance with the process according to the invention;

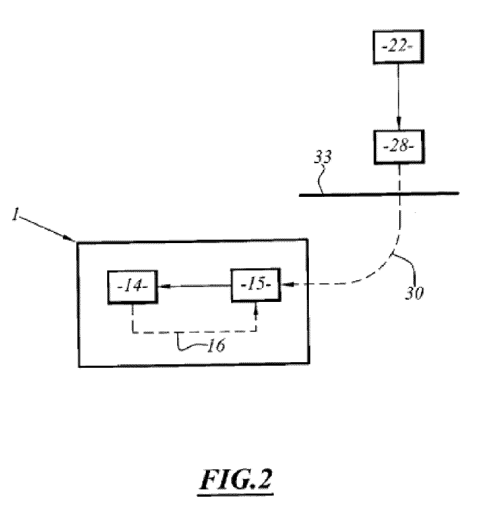

FIG. 2 is a schematic diagram of a particular device for implementing step (C) of the invention, for the specific case of use with a fuel cell;

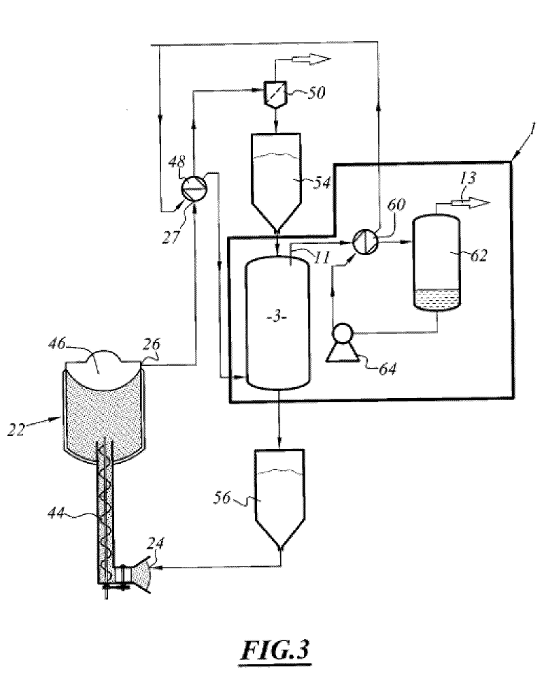

FIG. 3 is a diagram of a first variant of the facility according to the invention;

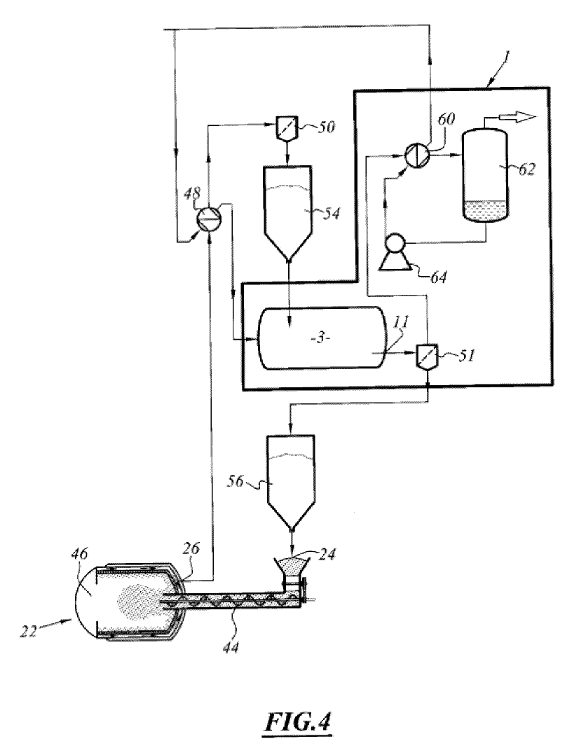

FIG. 4 is a diagram of a second variant of the facility according to the invention;

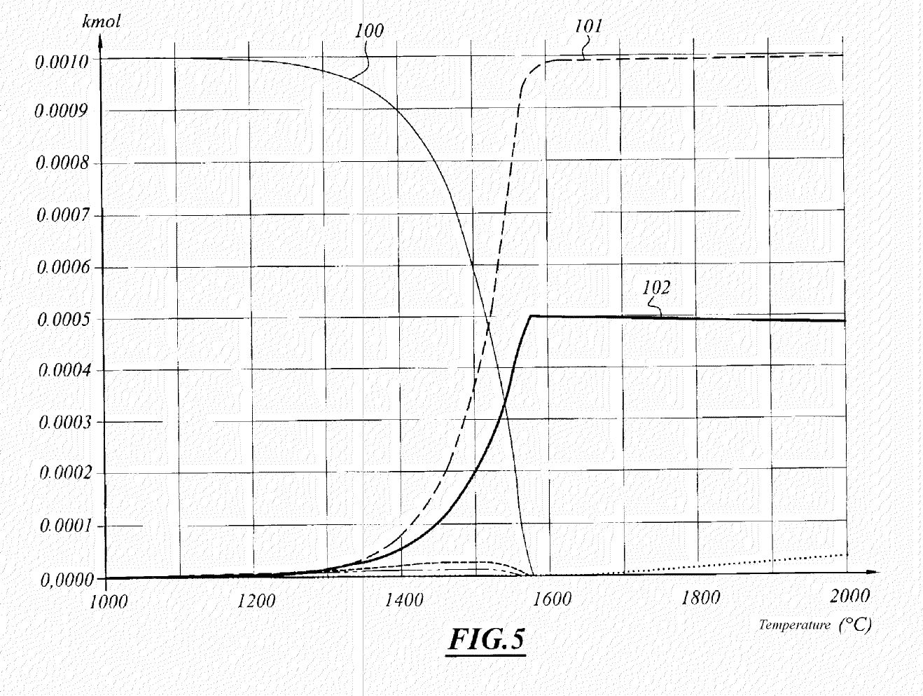

FIG. 5 is a graph showing the compositions at thermodynamic equilibrium as a function of temperature during the SnO₂ reduction process;

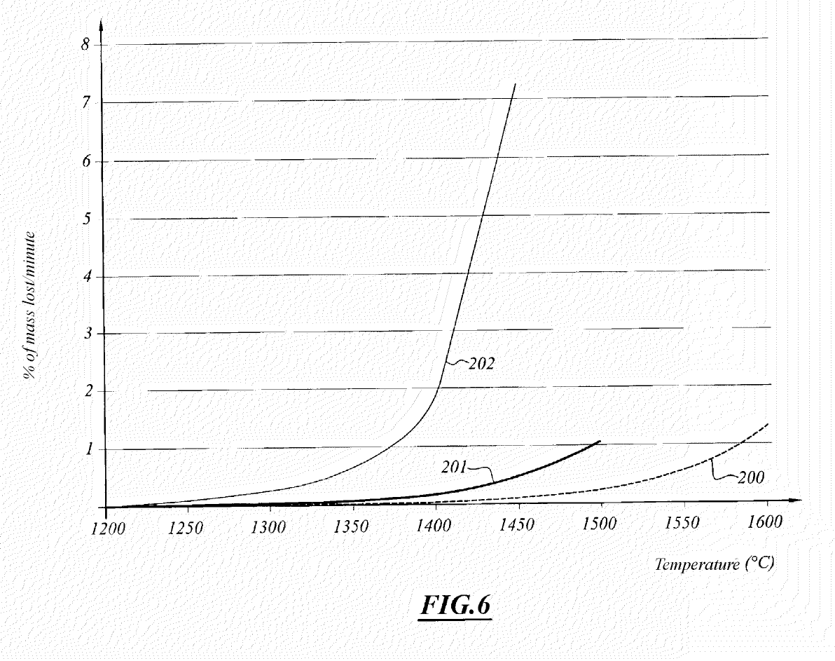

FIG. 6 is a graph showing the reaction rates of the SnO₂ reduction process as a function of temperature and pressure;

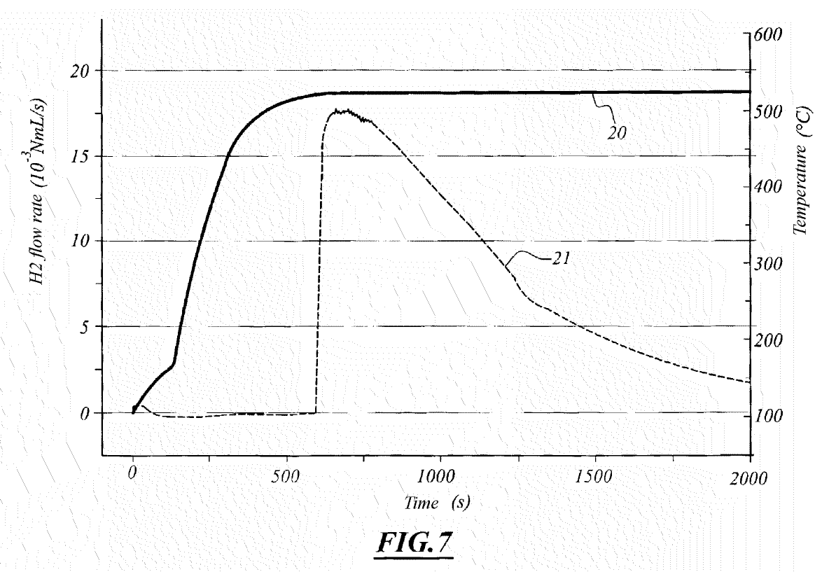

FIG. 7 is a graph showing the reaction rate of hydrogen production by hydrolysis of SnO under a flow of argon;

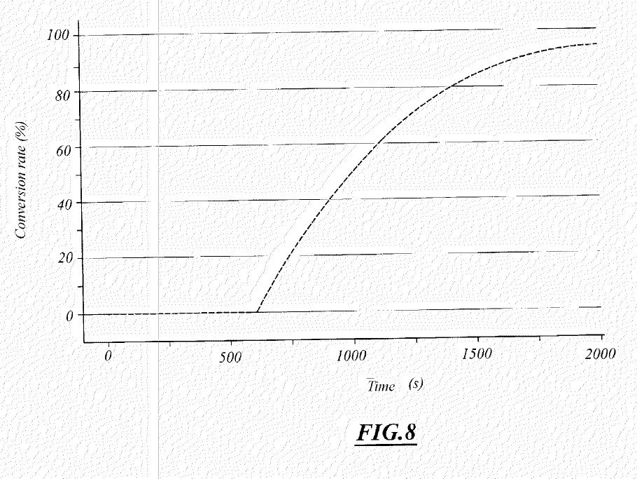

FIG. 8 is a graph showing the rate of conversion of SnO into H₂.

FIG. 1 shows means generally used to implement steps (A), (B) and (C) of the process of the invention. In particular, it describes a device 1 for implementing step (C) of the invention which comprises a hydrolysis reactor 3 provided with a first inlet 5 suitable for introducing solid SnO as obtained from steps (A) and (B) as defined above into the hydrolysis reactor 3, a second inlet 7 connected to means 9 for supplying water, generally in the form of water vapor, and an outlet 11 for discharging the hydrogen formed. The hydrolysis reactor 3 is heated by heating means of the conventional type (not shown) to a temperature of between 450° C. and 600° C., preferably between 475° C. and approximately 550° C. The device 1 may be used alone or integrated into the facility 20.

In one embodiment, the hydrolysis reactor 3 comprises a moving bed-type solid-gas contactor which promotes mass and heat transfer in order to optimize the reaction rate of the hydrolysis process and minimize the reaction time. This type of reactor is known as a “plug-flow reactor”.

In another embodiment, the water supply means 9 comprise, for example, a pipe or the like which can pass through a heat exchanger.

In addition, the device 1 comprises means 13 for recovering and/or enriching the dihydrogen formed at the outlet 11 of the hydrolysis reactor 3. The means 13 for recovering and/or enriching the hydrogen formed generally comprise means for separating the hydrogen and the excess water vapor introduced into the hydrolysis reactor 3. These separation means enable hydrogen of greater purity to be obtained. The separation means may for example, be a condenser which separates the hydrogen from the water vapor by condensing the water vapor.

In another embodiment, the means 13 for recovering and/or enriching the dihydrogen formed comprise a pipe or the like which enables hydrogen to be conveyed to a storage vessel and enriched for use as a fuel for example. The means 13 for recovering and/or enriching the dihydrogen formed therefore preferably comprise a fuel cell.

FIG. 2 thus shows the device of the invention associated with a fuel cell 14. The fuel cell used in this context generally comprises an electrolyte, a cathode and an anode. The anode is thus fed by the device 1 according to the invention which is used as a hydrogen generator supplying hydrogen to the anode in accordance with the hydrogen production step (C) of the invention. The device 1 is generally connected to a vessel 15 containing the solid SnO obtained in accordance with steps (A) and (B) of the process of the invention. The presence of this vessel 15 of solid SnO enables the fuel cell to be transported and thus has the advantage of solving the safety problems associated with the storage of hydrogen, since the hydrogen is stored in the form of solid SnO. SnO can thus be stored easily and more safely than hydrogen. Moreover, the reactivity of SnO with water does not change, even after being stored exposed to air. Hydrogen can thus be generated at its site of use from a vessel containing SnO. In the case of use in a fuel cell, the SnO provided according to the process of the invention generally assumes the role of an energy carrier, storing the thermal energy (generally of solar origin) in step (A) and delivering this energy in a chemical form (hydrogen) in step (C).

Furthermore, the vessel 15 of solid SnO comprises a water provision means 16 thus enabling the hydrolysis of solid SnO in accordance with step (C). The water used to hydrolyze SnO may be obtained directly from the outlet of the fuel cell 14 and all or part of the heat produced by the fuel cell 14 can be recovered to heat the water and the SnO. FIG. 2 therefore shows a particular example of the device of FIG. 1 in which the recovery and/or enrichment means 13 and the water supply means 9 are activated.

The fact that it is possible to design generators for producing hydrogen by means of rapidly reacting SnO with H₂O at a moderate temperature bypasses the problem of transporting and storing hydrogen. It is thus possible to envisage multiple applications of the system including those associated with hydrogen generation in the fields of stationary equipment such as generator sets, portable equipment or transport equipment.

When the fuel cell 14 is in operation, the solid SnO stored in the vessel 15 of solid SnO is brought into contact with water, thus producing hydrogen in accordance with the process according to the invention. The hydrogen formed is thus recovered at the anode and oxygen is injected at the cathode to provide electrical energy in accordance with the function of electrochemical cells. In operation, the fuel cell 14 thus enables the conversion, storage and transport of solar energy in the form of hydrogen to be achieved by using the SnO₂/SnO pair. For example, at ambient temperature, a PEMFC produces electrical energy of approximately 237 kJ/mol and an amount of heat of approximately 49 kJ/mol.

FIG. 1 is a more comprehensive representation of all of the means for implementing steps (A), (B) and (C). These steps may be implemented in a facility 20 for implementing the process of the invention comprising the device 1 according to the invention which is associated with a reactor 22 for reducing SnO₂ into SnO which is provided with conveying means 25 connected to an inlet 24 for introducing SnO₂ and an outlet 26 for discharging gaseous SnO. The reduction reactor 22 and hydrolysis reactor 3 are generally heated to two distinct temperature ranges. The reduction reactor 22 is further provided with means for heating, in particular by a source of thermal energy of solar origin, for example by means of solar concentrator technology of the type comprising a solar power tower and a heliostat field or a parabolic concentrator. In fact, the use of a source of concentrated thermal energy of solar origin enables temperatures greater than those provided by a heat source of nuclear origin, approximately 850° C. for generation IV nuclear reactors, to be obtained. Moreover, a source of thermal energy of solar origin has the advantage of being a non-polluting renewable source which can be used safely on an industrial scale.

In the case of a reduction reactor 22 heated by solar radiation, the solar receptor generally uses a solid intermediate means. This intermediate means is an absorber which transfers the energy to the reaction medium by conduction and/or convection and radiation. It preferably comprises either a wall which is opaque to solar radiation (system defined as an indirect absorption reactor), or particles (system defined as a direct absorption reactor). In a variant, a solid reagent such as solid SnO₂ acts as a direct absorber.

In an embodiment, the mode of heating used is indirect heating via a transfer wall which prevents the deposition of solid particles on the optical window, which is generally made of quartz or glass and allows solar radiation to pass through.

In a variant, the mode of heating is direct heating used in the case of a fixed bed of particles which are consumed by the reaction, or in the case of a continuous injection of particles which act as absorbers. In the latter case, the reduction reactor 22 is preferably provided with a cavity formed by a porous ceramic material which absorbs solar radiation. This type of reactor is known as an “open” reactor.

In another embodiment, the reduction reactor 22 is a “semi-batch” reactor which enables a fixed batch of solid SnO₂ to be treated, the reaction continuing until the batch is exhausted.

The facility 20 according to the invention further comprises SnO₂ conveying means 25 arranged upstream of the SnO₂ introduction inlet 24 of the reduction reactor 22. These SnO₂ conveying means 25 typically comprise an Archimedes' screw-type conveyor for solids.

The facility 20 according to the invention also comprises means 28 for cooling gaseous SnO which are connected to the outlet 26 for discharging gaseous SnO of the reduction reactor 22. These means 28 for cooling gaseous SnO generally comprise an inlet 27 for introducing gaseous SnO and an outlet 29 for discharging solid SnO.

The means 28 for cooling gaseous SnO preferably comprise a heat exchanger, the coolant of which comprises, or is water and in which the water supply means 9 comprise means for conveying the water heated in the heat exchanger to the second inlet 7 of the hydrolysis reactor 3. In this case, the water supply means 9 typically enable water to be supplied in the form of vapor used in the hydrolysis reactor 3 to hydrolyze solid SnO.

The heat exchanger is arranged at the outlet of the reduction reactor 22 and enables the recovery of the energy of the products SnO and O₂ contained in a gaseous flow issuing from the outlet 26 for discharging gaseous SnO of the reduction reactor 22. In an embodiment, the gas flow comprises an inert carrier gas such as Ar or N₂ in addition to gaseous SnO and O₂. The exchanger generally comprises a coolant such as water which absorbs the energy from the process of cooling gaseous SnO. If water is used as the coolant, the water is vaporized after thermal exchange during cooling and can be injected into the hydrolysis reactor 3. The gaseous species such as gaseous SnO and O₂ or solid SnO in suspension in the gas flow are generally conveyed in the pipes. In a variant, cooling may be carried out using an inert quenching gas injected into the gas mix containing SnO and O₂ at the outlet of the reduction reactor 22. For example, Ar or N₂ may be used for this purpose.

A filter may thus be positioned at the outlet of the means 28 for cooling gaseous SnO to separate the SnO particles from the gas flow containing O₂.

The facility 20 also comprises means 30 for conveying the solid SnO formed which are connected to the first inlet 5 of the hydrolysis reactor 3.

The facility according to the invention further comprises means 32 for extracting gaseous oxygen which are suitable for extracting the gaseous oxygen formed in the SnO₂ reduction process in the reduction reactor 3 and are arranged between the means 28 for cooling gaseous SnO and the inlet of the hydrolysis reactor 3. The phrase “between the means 28 for cooling gaseous SnO and the inlet of the hydrolysis reactor 3” in this case means that the means 32 for extracting gaseous oxygen are arranged either directly in the region of the means 28 for cooling gaseous SnO or downstream of the means 28 for cooling gaseous SnO and upstream of the inlet of the hydrolysis reactor 3. In either case, the means 32 for extracting gaseous oxygen are not positioned in the region of the inlet to the hydrolysis reactor 3. In particular, the oxygen is extracted from the mixture before said mixture reaches the inlet of the hydrolysis reactor 3. Specifically, the gaseous oxygen is to be removed from the reaction mixture of solid SnO and water vapor, since the oxygen would otherwise react violently with the hydrogen and would predominantly oxidize SnO to form SnO₂.

In an embodiment, the facility 20 further comprises SnO₂ recycling means 36 which enable SnO₂ to be transported from the SnO₂ discharge outlet 37 of the hydrolysis reactor 3 to the inlet of the reduction reactor 22. Upon its formation at the outlet of the hydrolysis reactor 3, SnO₂ is reused immediately in the reduction reactor 22 to form SnO once again. In an embodiment, the recycling means 36 comprise an SnO₂ storage vessel 40 which is located upstream of the conveying means 25 and supplies the reduction reactor 22 with SnO₂.

In an embodiment, the SnO₂ recycling means 36 also comprise a filter, the outlet of which is connected to the SnO₂ storage vessel 40. This SnO₂ storage vessel 40 then allows the reduction reactor 22 to be fed with SnO₂.

The facility 20 may typically be used as an industrial hydrogen production unit. Generally, this production unit stores hydrogen for sale in its present state, for example, or for subsequent enrichment. In a possible variant, the hydrogen produced may also be enriched immediately, i.e. without intermediate storage.

In a particular embodiment, the device 1 may be used at a site which is different to that where the solid SnO is produced. In this case, the conveying means 30 which allow the solid SnO recovered from the oxygen extraction means 32 to be transported to the site where the reactor 3 of the device 1 is used, is shown schematically by the dashed arrow representing these means 30.

The embodiment in which the device 1 is used at a site different to that where solid SnO is produced is shown in particular in FIG. 2, in which the solid SnO which is stored in the vessel 15 of solid SnO via the conveying means 30 originates from the reduction of SnO₂ in a reduction reactor 22 of the type described above. After SnO₂ has been reduced into gaseous SnO and O₂, gaseous SnO is cooled in cooling means 28 as described above which causes it to condense into particles of solid SnO. These solid SnO particles are subsequently separated from gaseous O₂, typically by filtration using a filter 33, shown schematically in FIG. 2.

Once the solid SnO has been isolated, for example by means of the aforementioned filter 33, it may thus be stored in the vessel 15 of solid SnO for the purpose of being subsequently hydrolyzed, thus providing the hydrogen required for the operation of the fuel cell 14 as described above.

In operation, according to FIGS. 3 and 4, SnO₂ is introduced into the SnO₂ introduction inlet 24 of the reaction reactor 22, the Archimedes' screw 44 feeding the reduction reactor 22 with solid SnO₂ in order to keep the bed of SnO₂ particles constant.

The endothermic reduction step (A) (ΔH=557 kJ.mol⁻¹_{SnO2} at 1,630° C.) is carried out in the reduction reactor 22, in which SnO₂ is reduced into gaseous O₂ and gaseous SnO by heating the reduction reactor 22 by means of a source of thermal energy of solar origin (not shown).

The device (not shown) for concentrating the solar heat is, for example, a parabolic-type concentrator or a solar power tower and a heliostat field.

The reduction reactor 22 is an “open” reduction reactor which allows SnO₂ particles to be injected continuously and solid SnO to be extracted and recovered. In this case, the SnO₂ particles are injected into the centre of the cavity 46 formed of porous ceramic material. The reduction reaction is produced on contact with the surface of the porous ceramic material, which is at an elevated temperature.

In a variant (not shown), the reduction reactor 22 is a “semi-batch” reactor which allows a fixed batch of solid SnO₂ to be treated, the reaction continuing until it is exhausted.

The reduction reactor 22 preferably operates under a controlled inert atmosphere and at low pressure. A flow of inert flushing gas such as Ar or N₂ is thus injected into the chamber of the reduction reactor 22 to carry the products of the reduction reaction, gaseous SnO and O₂, to the inlet 27 for introducing gaseous SnO of the means 28 for cooling gaseous SnO.

In the case of an “open” reduction reactor, the gaseous products, SnO and O₂, carried by the inert gas flow, pass through the ceramic layer by means of a pumping system positioned at the outlet.

The volatility of the gaseous SnO formed advantageously facilitates the transport thereof by the flow of inert gas such as Ar or N₂ from the reduction zone to the outlet 26 for gaseous SnO of the reduction reactor 22. The gas flow comprising gaseous SnO is, for example, transported by a pipe or the like. As it is transported, the gaseous SnO condenses rapidly, generally into the form of solid nanoparticles once the temperature becomes less than or equal to 1,530° C.

A heat exchanger 48 is positioned downstream of the outlet 26 for discharging gaseous SnO in the path of the reaction products, gaseous SnO and O₂. This exchanger enables the sensible heat of the products produced in the reduction reaction to be recovered. The heat exchanger 48 advantageously contains water as a coolant and thus recovers the heat emitted when the gaseous SnO is cooled in order to provide the energy input required for the production of water vapor which is supplied to the hydrolysis reactor 3. In this case, the heat exchanger 48 is thus also a means 9 for supplying water by vaporizing water to feed the hydrolysis reactor 3.

At the outlet from this heat exchanger 48, solid SnO is carried towards a first cyclonic system or a first filtration system which separates the solid SnO from the gas flow. The solid SnO particles are thus separated by a solid SnO filter 50 with a cut-off of several nanometers, preferably less than or equal to 10 nm, corresponding to the ultrafiltration range.

The solid SnO filter 50 further comprises means 32 for extracting gaseous oxygen which enable the oxygen to be separated from the solid SnO particles and thus enable any contact between oxygen and dihydrogen to be avoided.

The solid SnO particles of greater than approximately 10 nm which were filtered out by the solid SnO filter 50 are subsequently collected in a vessel 54 for storing solid SnO.

This vessel 54 for storing solid SnO feeds the hydrolysis reactor 3 in which the exothermic hydrolysis step (C) (ΔH=−49 kJ/mol at 500° C.) takes place. The fact that the hydrolysis reaction is exothermic allows an energy input which is sufficient to maintain the hydrolysis reactor 3 at the reaction temperature to be provided.

The hydrolysis reactor 3 comprises a moving bed-type solid-gas contactor which promotes mass and heat transfer so as to optimize the hydrolysis reaction rate and minimize the reaction time.

In the embodiment shown in FIG. 4, a nanoscale suspension of solid SnO from the vessel 54 for storing solid SnO is carried continuously through a tube furnace by a gas flow containing water vapor.

At the outlet of the hydrolysis reactor 3, the solid SnO has reacted completely to form SnO₂, which is then recycled in the reduction step. A conveyor for solids is thus used to transport the SnO₂ formed in the hydrolysis reactor 3 from an SnO₂ storage vessel 56 which is connected to an outlet for discharging SnO₂ of the hydrolysis reactor 3. The vessel 56 for storing SnO₂ is thus connected to the SnO₂ introduction inlet 24 of the reduction reactor 22. In the embodiment shown in FIG. 4, a filter 51 for SnO₂ particles is positioned at the outlet of the hydrolysis reactor 3. SnO₂ formed in the hydrolysis reaction is thus transported towards the SnO₂ storage vessel 56, which enables water and gaseous hydrogen to be separated from the solid SnO₂ particles.

The gas flow from the hydrolysis reactor 3 is composed of excess water vapor and hydrogen. This flow passes into a second exchanger 60 which is arranged at the hydrogen discharge outlet 11. The hydrogen is then separated from the water by condensation in the condenser 62 and is then recovered. The condenser 62 is arranged following the second exchanger 60. The liquid water may be transported using a pump 64 arranged between a liquid water outlet of the condenser 62 and the second exchanger 60. The liquid water passing through the exchanger 60 is thus heated by the gas flow from the hydrolysis reactor 3 when said water passes through the second exchanger 60. The heated liquid water then passes into the first exchanger 48 which heats this water further and vaporizes it by means of the gas flow issuing from the reduction reactor 22. Make-up water is required to make up for the water consumed by the hydrolysis reaction.

Study of the First Step: SnO₂ Reduction Reaction

FIG. 5 shows the compositions of SnO₂ (curve 100), SnO (curve 101) and O₂ (curve 102) at thermodynamic equilibrium as a function of the temperature T during the reduction of one mole of SnO₂ 100 at 1 atm.

According to FIG. 5, the reduction of SnO₂ (curve 100) into SnO (curve 101) is complete at 1,600° C. at atmospheric pressure.

FIG. 6 shows the reaction rates for the decomposition of SnO₂ at different pressures (curve 200 at atmospheric pressure, curve 201 at 0.1 bar and curve 202 at 0.01 bar). Overall, the rate of the SnO₂ reduction reaction increases with an increase in temperature and a decrease in pressure. The loss of mass observed when heating the sample is due solely to the reaction which produces SnO in a gaseous phase. No competition with the vaporization of SnO₂ is expected since the vaporization temperature of SnO₂ is very high (Tᵥₐₚ=2,500° C.). The reaction of reducing SnO₂ into SnO is a first order reaction and the rate constants were determined on the basis of Arrhenius' law k=k₀.exp(−Eₐ/RT) where Eₐ=424 kJ/mol and k₀=1.4×10⁸ s⁻¹ at atmospheric pressure. A decrease in the pressure or an increase in the gas flow rate thus accelerates the reaction rate.

Study of the Second Step: SnO Hydrolysis Reaction

The maximum temperature of the hydrolysis reaction is limited to 600° C. in order to prevent the disproportionation of SnO into SnO₂ and into Sn (2SnO→SnO₂+Sn).

FIG. 7 shows the results of a hydrolysis reaction carried out at 525° C. The curve 20 shows that the temperature reaches 525° C. after 400 s. The curve 21 shows the hydrogen flow rate produced over the course of time at the outlet of the hydrolysis reactor. The process according to the invention attains H₂ production with a final conversion rate of greater than 90% at 525° C.

FIG. 8 shows the conversion rate of the reaction as a function of time. This rate is approximately 90% in 19 minutes. Furthermore, the large exchange area available on account of the solid SnO nanoparticles enables a rapid hydrolysis reaction to be achieved.

1. A hydrogen production process comprising a step (C) of hydrolyzing solid SnO which produces hydrogen, wherein the hydrogen produced is stored, recovered and/or enriched and the solid SnO used is obtained in accordance with the following steps:
(A) thermal reduction of SnO₂ to form SnO in conditions resulting in gaseous SnO; and
(B) cooling of the gaseous SnO thus produced to a temperature lower than or equal to 550° C.

2. The process of claim 1, wherein all or part of the SnO₂ formed in step (C) is recycled in step (A), by means of which the successive steps (A), (B) and (C) are implemented in the form of a cycle carrying out the thermochemical cycle represented by the following balanced reactions:
Step 1: SnO₂→SnO+½O₂
Step 2: SnO+H₂O→SnO₂+H₂.

3. The process of any of claim 1, wherein step (A) is carried out at a temperature of between 1,530° C. and 2,500° C. at atmospheric pressure.

4. The process of claim 1, wherein the thermal reduction in step (A) is carried out by using thermal energy from a source of solar origin.

5. The process of claim 1, wherein the cooling in step (B) is a quenching process producing solid SnO particles with a particle size of between 1 nm and 100 nm.

6. The process of claim 1, wherein the hydrolysis in step (C) is carried out at a temperature of less than 600° C. at atmospheric pressure.

7. The process of claim 1, wherein the water used in the hydrolysis step (C) is in the form of water vapor.

8. The process of claim 7, wherein said water vapor used in the hydrolysis step (C) is supplied by a heat exchanger, the coolant of which is water, said heat exchanger recovering at least some of the heat from the cooling process in step (B).

9. A device (1) for implementing step (C) of the process of claim 1, comprising:
a solid-gas hydrolysis reactor of the plug-flow type provided with:
a first inlet for introducing solid SnO, as obtained from steps (A) and (B) as defined in claim 1, into said hydrolysis reactor; and
a second inlet connected to water vapor supply means;
an outlet for discharging the hydrogen formed;
heating means; and
means for recovering and/or enriching the dihydrogen formed at the outlet of the hydrolysis reactor.

10. A fuel cell comprising the device of claim 9 as a hydrogen generator.

11. A facility for implementing the process of claim 1, comprising:
a device for implementing step (C) of the process of claim 1, comprising:
a solid-gas hydrolysis reactor of the plug-flow type provided with:
a first inlet for introducing solid SnO, as obtained from steps (A) and (B) as defined in claim 1, into said hydrolysis reactor; and
a second inlet connected to water vapor supply means;
an outlet for discharging the hydrogen formed;
heating means; and
means for recovering and/or enriching the dihydrogen formed at the outlet of the hydrolysis reactor,
wherein the device for implementing step (C) is associated with:
a reactor for reducing SnO₂ into SnO provided with conveying means connected to an inlet for introducing SnO₂ and an outlet for discharging gaseous SnO;
means for cooling the gas flow containing gaseous SnO which are connected to the outlet of the reduction reactor and are suitable for converting gaseous SnO into solid SnO;
means for conveying solid SnO from the cooling means, the conveying means being connected to the first inlet of the hydrolysis reactor.

12. The facility of claim 11, wherein the reduction reactor is further provided with means for heating by way of a source of thermal energy of solar origin.

13. The facility of claim 11, wherein the means for cooling gaseous SnO comprise a heat exchanger, the coolant of which comprises water, and wherein the water supply means comprise means for conveying the water heated in the heat exchanger towards the second inlet of the hydrolysis reactor.

14. The facility of claim 11, wherein the means for recovering and/or enriching the hydrogen formed further comprise a means for separating the hydrogen from the excess water vapor introduced into the hydrolysis reactor.

15. The facility of claim 11, further comprising SnO₂ recycling means which enable SnO₂ to be transported from the outlet of the hydrolysis reactor to the inlet of the reduction reactor.

16. The facility of claim 11, further comprising means for extracting gaseous oxygen which are suitable for extracting gaseous oxygen and are arranged between the means for cooling gaseous SnO and the inlet of the hydrolysis reactor.

17. The facility of claim 11 which is an industrial hydrogen production unit.
